(19) United States
(12) Patent Application Publication
(10) Pub. No.: US 2024/0329594 A1
(43) Pub. Date: Oct. 3, 2024

(54) DEVELOPING DEVICE AND IMAGE FORMING APPARATUS

(71) Applicant: FUJIFILM Business Innovation Corp., Tokyo (JP)

(72) Inventors: Yasuhisa GONDA, Kanagawa (JP); Koji YOSHITSUGU, Kanagawa (JP); Yuka NOMURA, Kanagawa (JP)

(73) Assignee: FUJIFILM Business Innovation Corp., Tokyo (JP)

(21) Appl. No.: 18/452,863

(22) Filed: Aug. 21, 2023

(30) Foreign Application Priority Data
Mar. 29, 2023 (JP) 2023-052828

(51) Int. Cl. G03G 21/16; G03G 15/08

(52) U.S. Cl. CPC G03G 21/1676; G03G 15/0872; G03G 15/0886

(57) ABSTRACT

A developing device includes: a housing; a rotary part that is rotatably disposed in the housing; a seal part that seals an end of the rotary part in an axial direction; and a heat releasing part that is made of a material having a higher thermal conductivity than the housing and that is in contact with the seal part to release heat of the seal part to the outside.

### CROSS-REFERENCE TO RELATED APPLICATIONS

This application is based on and claims priority under 35 USC 119 from Japanese Patent Application No. 2023-052828 filed Mar. 29, 2023.

### BACKGROUND

### (i) Technical Field

The present disclosure relates to developing devices and image forming apparatuses.

### (ii) Related Art

Technologies related to developing devices have been proposed.

Japanese Unexamined Patent Application Publication No. 2015-082056 discloses a configuration in which, when a developing unit in a state of being attached to an apparatus body moves from a separation position to a contact position, a protrusion comes off a guide groove, creating a space between the protrusion and the guide groove. Thus, heat generated in the developing unit is released into the space through the protrusion.

Japanese Unexamined Patent Application Publication No. 2003-057927 discloses a configuration in which vent holes are provided, each communicating between a space between a bearing and a seal member in the axial direction and the outside of a developing device. This configuration allows heat at both ends of a developer transport member in the axial direction to be released outside the developing device.

Japanese Unexamined Patent Application Publication No. 2000-112228 discloses a bearing device that supports, with a slide bearing, a rotary shaft of a rotary member disposed in a housing of a developing device. The bearing device includes a cap member that is made of a material having excellent thermal conductivity. The cap member is adhered to the inner surface of a housing of the slide bearing, with at least a portion thereof being exposed to the inside of the housing.

### SUMMARY

Aspects of non-limiting embodiments of the present disclosure relate to releasing, directly to the outside, heat of a seal part that seals an end of a rotary part in the axial direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including: a housing; a rotary part that is rotatably disposed in the housing; a seal part that seals an end of the rotary part in an axial direction; and a heat releasing part that is made of a material having a higher thermal conductivity than the housing and that is in contact with the seal part to release heat of the seal part to the outside.

### BRIEF DESCRIPTION OF THE DRAWINGS

Exemplary embodiments of the present disclosure will be described in detail based on the following figures, wherein:

FIG. 1 illustrates an overall configuration of an image forming apparatus incorporating a developing device according to a first exemplary embodiment of the present disclosure;

FIG. 2 illustrates a configuration of the developing device according to the first exemplary embodiment of the present disclosure;

FIG. 3 is a sectional view illustrating a configuration of the relevant part of the developing device according to the first exemplary embodiment of the present disclosure;

FIG. 4 is a sectional view illustrating a configuration of the relevant part of the developing device according to the first exemplary embodiment of the present disclosure;

FIG. 5 is a sectional view illustrating a configuration of the relevant part of the developing device according to the first exemplary embodiment of the present disclosure;

FIG. 6 is an enlarged sectional view of the relevant part in FIG. 5;

FIG. 7 schematically illustrates a flow of developer in the developing device according to the first exemplary embodiment of the present disclosure;

FIG. 8 is a sectional view illustrating a configuration of the relevant part of a developing device according to a second exemplary embodiment of the present disclosure;

FIG. 9 is a sectional view illustrating a configuration of the relevant part of a developing device according to a third exemplary embodiment of the present disclosure;

FIG. 10 illustrates a configuration of the relevant part of a developing device according to a fourth exemplary embodiment of the present disclosure;

FIGS. 11A and 11B illustrate a configuration of the relevant part of the developing device according to the fourth exemplary embodiment of the present disclosure; and

FIGS. 12A and 12B illustrate a configuration of the relevant part of the developing device according to the fourth exemplary embodiment of the present disclosure.

### DETAILED DESCRIPTION

Exemplary embodiments of the present disclosure will be described below with reference to the drawings.

### First Exemplary Embodiment

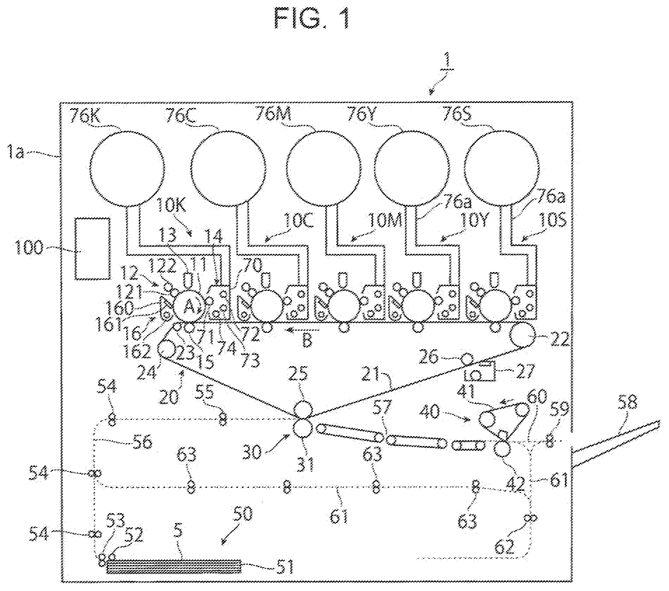

FIG. 1 illustrates an overall configuration of an image forming apparatus incorporating a developing device according to a first exemplary embodiment of the present disclosure.

### Overall Configuration of Image Forming Apparatus

The image forming apparatus 1 according to the first exemplary embodiment is, for example, a color printer. As illustrated in FIG. 1, the image forming apparatus 1 includes: multiple image forming devices 10 that form toner images developed with toner constituting developer; an intermediate transfer device 20 that holds the toner images formed by the image forming devices 10 and transports the toner images to a second transfer position where the toner images are finally transferred to recording paper 5, which is an example of a recording medium; a paper feeder 50 that accommodates and transports the recording paper 5 to be fed to the second transfer position of the intermediate transfer device 20; and a fixing device 40 that fixes the toner images on the recording paper 5 that have been second-transferred by the intermediate transfer device 20. As illustrated in FIG. 1, the image forming apparatus 1 includes an apparatus body 1a. The apparatus body 1a includes a support structural member and an exterior cover. Dashed lines in FIG. 1 indicate transport paths in the apparatus body 1a, along which the recording paper 5 is transported.

The image forming devices 10 include five image forming devices, 10S, 10Y, 10M, 10C, and 10K, that form toner images of five colors, i.e., a special color (S), yellow (Y), magenta (M), cyan (C), and black (K), respectively. The five image forming devices 10 (S, Y, M, C, and K) are arranged horizontally in a row in the internal space of the apparatus body 1a. The special color (S) herein refers to a specific color used for forming an image in the image forming apparatus 1. Examples of toner of the special color (S) include, but not limited to, transparent toner for improving the gloss of an image formed on recording paper 5, metallic color toner such as gold or silver, and so-called corporate color toner used by a specific company.

As illustrated in FIG. 1, the image forming devices 10 (S, Y, M, C, and K) each include a rotatable photoconductor drum 11, which is an example of a latent image carrier. The photoconductor drum 11 is surrounded by: a charging device 12 that charges the circumferential surface (image holding surface) of the photoconductor drum 11, on which an image can be formed, to a predetermined potential; an exposure device 13 that irradiates the charged circumferential surface of the photoconductor drum 11 with light based on image information (signal) to form an electrostatic latent image having a potential difference; a developing device 14, which is an example of a developing part, that develops the electrostatic latent image with toner in developer to form a toner image; a first-transfer device 15 that transfers the toner image to the intermediate transfer device 20; and a drum cleaning device 16 that cleans the image holding surface of the photoconductor drum 11 by removing deposits such as toner remaining on the image holding surface after the first-transfer.

The photoconductor drum 11 includes a hollow or solid cylindrical base member to be grounded, and the image holding surface formed on the circumferential surface thereof. The image holding surface has a photoconductive layer (photosensitive layer) that is made of a photoconductive material. The photoconductor drum 11 is supported so as to rotate in an arrow A direction when receiving a driving force from a driving unit (not illustrated).

The charging device 12 includes a contact-type charging roller 121 disposed in contact with the photoconductor drum 11. A cleaning roller 122 is in contact with the charging roller 121, on the side thereof opposite to the photoconductor drum 11, to clean the surface of the charging roller 121. A charging voltage is supplied to the charging device 12. The charging voltage is a voltage or current having the same polarity as the charge polarity of the toner supplied from the developing device 14, when the developing device 14 performs reversal development.

The exposure device 13 includes a light-emitting-diode (LED) print head that irradiates the photoconductor drum 11 with light corresponding to image information with multiple LEDS, serving as light emitting elements, arranged in the axial direction of the photoconductor drum 11 to form an electrostatic latent image. The exposure device 13 may alternatively deflect and scan laser light corresponding to image information in the axial direction of the photoconductor drum 11.

Each of the developing devices 14 (S, Y, M, C, and K) includes a casing 70 having a developer chamber and an opening facing the photoconductor drum 11. The casing 70 accommodates: a developing roller 71 that holds and transports developer to a developing area where the developing roller 71 faces the photoconductor drum 11; a stirring-supply member 72, which may be a screw auger, that supplies the developer such that the developer passes through the developing roller 71 while stirring the developer; a stirring-transport member 73, which may be a screw auger, that transports the developer to the stirring-supply member 72 while stirring the developer; a stirring-collecting member 74, which may be a screw auger, that transports the developer that is unused in development and separated from the developing roller 71 to an end of the stirring-supply member 72; and a layer-thickness regulating member 75 that regulates the amount of developer (layer thickness) held on the developing roller 71. In the developing device 14, a developing voltage is supplied between the developing roller 71 and the photoconductor drum 11 from a power supply device (not illustrated). The five color developers are, for example, two-component developers each containing non-magnetic toner and magnetic carrier. The configuration of the developing device 14 will be described in detail below.

The first-transfer devices 15 (S, Y, M, C, and K) are contact-type transfer devices including first transfer rollers that roll on the circumferences of the corresponding photoconductor drums 11 with the intermediate transfer belt 21 therebetween and to which first transfer voltages are supplied. DC voltages having a polarity opposite to the charge polarity of the toner are supplied as the first-transfer voltages from power supply devices (not illustrated).

Each drum cleaning device 16 includes a container-like body 160 having an opening, a cleaning plate 161 disposed so as to be in contact with the circumferential surface of the photoconductor drum 11 after the first transfer with a predetermined pressure to remove deposits such as residual toner, and a delivery member 162, which may be a screw auger, that collects the deposits removed by the cleaning plate 161 and delivers the deposits to a collection system (not illustrated). The cleaning plate 161 may be a plate-like member (e.g., a blade) made of rubber.

As illustrated in FIG. 1, the intermediate transfer device 20 is disposed below the image forming devices 10 (S, Y, M, C, and K) in the vertical direction. The intermediate transfer device 20 includes: the intermediate transfer belt 21 that rotates in an arrow B direction while passing through the first transfer positions between the photoconductor drums 11 and the first-transfer devices 15 (first-transfer rollers); multiple belt support rollers 22 to 26 that support the intermediate transfer belt 21 in a desired state from the inner surface thereof so as to allow rotation thereof; a second transfer device 30 that is disposed on the outer circumferential surface (image holding surface) of the intermediate transfer belt 21, supported by the belt support rollers 22 to 26, and second-transfers toner images on the intermediate transfer belt 21 to recording paper 5; and a belt cleaning device 27 that cleans the outer surface of the intermediate transfer belt 21 after passing through the second transfer device 30 by removing deposits such as toner and paper dust.

The intermediate transfer belt 21 is an endless belt made of, for example, a material containing a synthetic resin, such as polyimide resin or polyamide resin, and a resistance adjusting agent, such as carbon black, dispersed therein. The belt support roller 22 serves as a driving roller rotationally driven by a driving device (not illustrated), the belt support roller 23 serves as a flattening roller for holding the image forming surface of the intermediate transfer belt 21, the belt support roller 24 serves as a tension roller that applies tension to the intermediate transfer belt 21, the belt support roller 25 serves as an opposing roller for the second transfer device 30, and the belt support roller 26 serves as a support roller for supporting the back surface of the belt cleaning device 27.

As illustrated in FIG. 1, the second transfer device 30 is a contact-type transfer device including a second transfer roller 31. The second transfer roller 31 is in contact with the circumferential surface of the intermediate transfer belt 21 and rotates at the second transfer position, which is a portion of the outer circumferential surface of the intermediate transfer belt 21 supported by the belt support roller 25 in the intermediate transfer device 20. The second transfer roller 31 is supplied with a second transfer voltage. The second transfer voltage is a DC voltage supplied from a power supply device (not illustrated) to the second transfer roller 31 or the belt support roller 25 of the intermediate transfer device 20. The DC voltage has a polarity the same as or opposite to the charge polarity of the toner.

The fixing device 40 includes a heating rotary member 41, which may be either a belt or a roller, and a pressing rotary member 42, which may be either a belt or a roller, accommodated in a housing (not illustrated) having entrance and exit ports for recording paper 5. The heating rotary member 41 is heated by a heating unit such that the surface thereof is maintained at a predetermined temperature, and rotates in the direction indicated by the arrow. The pressing rotary member 42, which extends substantially in the axial direction of the heating rotary member 41, is in contact with the heating rotary member 41 at a predetermined pressure and is rotated in a driven manner. In the fixing device 40, a predetermined fixing process (heating and pressing) is performed at the contact portion where the heating rotary member 41 and the pressing rotary member 42 are in contact with each other.

The paper feeder 50 is disposed below the intermediate transfer device 20. The paper feeder 50 includes at least one paper accommodating body 51 that accommodates a stack of recording paper 5 of a desired size, type, etc., and feeding devices 52 and 53 that feed the recording paper 5 one by one from the paper accommodating body 51. The paper accommodating body 51 can be drawn out, for example, to the front side (i.e., the side on which a user stands when operating) of the apparatus body 1a.

Examples of the recording paper 5 include plain paper, thin paper such as tracing paper, and OHP sheets that are used in electrophotographic copying machines, printers, etc. To achieve even higher smoothness of the surface of the fixed image, it is desirable to use recording paper 5 having smoother surface. Hence, coated paper, which is plain paper coated with a resin or the like, thick paper having a relatively large grammage, such as art paper for printing, and other paper may also be suitably used.

A paper feed/transport path 56 extends between the paper feeder 50 and the second transfer device 30. The paper feed/transport path 56 includes one or more paper transport roller pairs 54 and 55 and transport guides (not illustrated) that transport recording paper 5 fed from the paper feeder 50 to the second transfer position. The paper transport roller pair 55 disposed immediately before the second transfer position in the paper feed/transport path 56 serves as, for example, rollers for adjusting the transport timing of the recording paper 5 (i.e., registration rollers). A paper transport path 57 extends between the second transfer device 30 and the fixing device 40 to transport the recording paper 5 after the second transfer from the second transfer device 30 to the fixing device 40. An output transport path 60 for discharging the recording paper 5 after going through fixing in the fixing device 40 to a paper output part 58 by a paper output roller pair 59 extends through a side surface of the apparatus body 1a of the image forming apparatus 1.

The image forming apparatus 1 also includes a duplex paper transport path 61 that is used to form images on both sides of recording paper 5. The duplex paper transport path 61 guides the recording paper 5 having an image formed on one side downward to a paper reversing roller pair 62, not to the paper output part 58 via the paper output roller pair 59. In the duplex paper transport path 61, when the paper reversing roller pair 62 is reversely rotated, the recording paper 5 is reversed and transport to the paper feed/transport path 56 again by means of multiple transport roller pairs 63 and transport guides (not illustrated).

In FIG. 1, reference numerals 76 (S, Y, M, C, and K) denote toner cartridges, which are an example of developer containers, that store developer containing at least toner to be supplied to the corresponding developing device 14. In this exemplary embodiment, the toner cartridges 76 (S, Y, M, C, and K) accommodate replenishment developer composed of toner and carrier.

In FIG. 1, reference numeral 100 denotes a control device that comprehensively controls the operation of the image forming apparatus 1. The control device 100 includes a central processing unit (CPU), a read-only memory (ROM), a random-access memory (RAM), a bus connecting them, and a communication interface, which are not illustrated.

### Operation of Image Forming Apparatus

A basic image forming operation performed by the image forming apparatus 1 will be described below.

Herein, an operation in a full-color mode will be described, in which a full-color image is formed by combining five colors (S, Y, M, C, and K), including the special color, using the five image forming devices 10 (S, Y, M, C, and K).

When the image forming apparatus 1 receives image information and command information requesting a full-color image forming operation (printing) from a personal computer, an image reading device, or the like (not illustrated), the control device 100 actuates the five image forming devices 10 (S, Y, M, C, and K), the intermediate transfer device 20, the second transfer device 30, the fixing device 40, and the like. The image information of the special color (S) may be generated by the control device 100.

As illustrated in FIG. 1, in each of the image forming devices 10 (S, Y, M, C, and K), the photoconductor drum 11 rotates in the arrow A direction, and the charging device 12 charges the surface of the photoconductor drum 11 to a predetermined polarity (negative polarity in the first exemplary embodiment) and a predetermined potential. Subsequently, the exposure device 13 irradiates the charged surface of the photoconductor drum 11 with light based on a signal of an image obtained in the form converted to the corresponding color component (S, Y, M, C, or K) to form, on the surface of the photoconductor drum 1, a color-component electrostatic latent image having a certain potential difference.

Subsequently, in each of the image forming devices 10 (S, Y, M, C, and K), the toner of the corresponding color (S, Y, M, C, or K) charged to the required polarity (negative polarity) is supplied from the developing roller 71 to allow the toner to be electrostatically attached to the color-component electrostatic latent image formed on the photoconductor drum 11 and to develop the electrostatic latent image. As a result, the color-component electrostatic latent images formed on the photoconductor drums 11 are visualized as toner images of five colors (S, Y, M, C, and K) developed with the toner of the corresponding colors.

Then, the toner images of the five colors formed on the photoconductor drums 11 of the image forming devices 10 (S, Y, M, C, and K) are transported to the first-transfer positions and are first-transferred to the intermediate transfer belt 21 of the intermediate transfer device 20, which rotates in the arrow B direction, in a superimposed manner by the first-transfer devices 15 (S, Y, M, C, and K). The toner image of the special color (S) does not necessarily have to be superimposed on another toner image.

After the first transfer, in the image forming devices 10 (S, Y, M, C, and K), the drum cleaning devices 16 scrape off and remove the deposits to clean the surfaces of the photoconductor drums 11. This makes the image forming devices 10 (S, Y, M, C, and K) ready for the next image forming operation.

In the intermediate transfer device 20, the first-transferred toner images are held and transported to the second transfer position by the rotation of the intermediate transfer belt 21. The paper feeder 50 feeds recording paper 5 to the paper feed/transport path 56 in accordance with the image forming operation. In the paper feed/transport path 56, the paper transport roller pair 55, serving as registration rollers, feeds the recording paper 5 to the second transfer position in accordance with the transfer timing.

At the second transfer position, the second transfer device 30 collectively second-transfers the toner images on the intermediate transfer belt 21 to the recording paper 5. After the second transfer, in the intermediate transfer device 20, the belt cleaning device 27 removes the deposits, such as residual toner, on the surface of the intermediate transfer belt 21 to clean the intermediate transfer belt 21.

The recording paper 5, to which the toner images have been second-transferred, is separated from the intermediate transfer belt 21 and transported to the fixing device 40 through the paper transport path 57. In the fixing device 40, the recording paper 5 after the second transfer passes through the contact portion between the heating rotary body 41 and pressing rotary body 42, which are rotating, to be subjected to a necessary fixing process (heating and pressing). Thus, the unfixed toner image is fixed to the recording paper 5. After the fixing, the recording paper 5 is discharged to, for example, the paper output part 58 provided on a side surface of the apparatus body 1a by the paper output roller pair 59.

Through the above-described operation, the recording paper 5 having a full-color image, composed of five color toner images, is output.

### Configuration of Developing Device

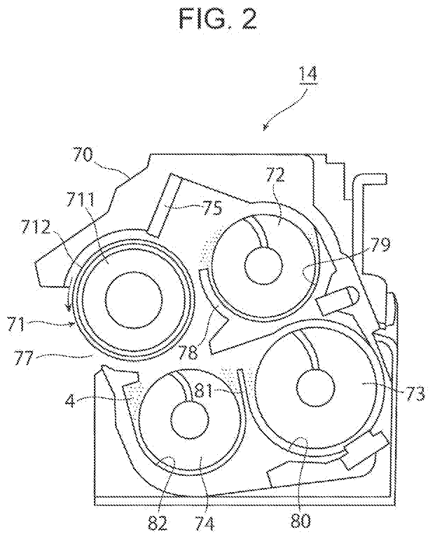

FIG. 2 illustrates a configuration of the developing device used in the image forming apparatus configured as described above.

As illustrated in FIG. 2, the developing device 14 according to the first exemplary embodiment includes the housing 70 having a rectangular cross-section. The housing 70 of the developing device 14 is an elongated substantially rectangular-parallelepiped box extending in the axial direction of the photoconductor drum 11. The box is formed of a synthetic resin component divided into multiple sections along the vertical, horizontal, or longitudinal direction as necessary. The housing 70 has, in the side surface facing the photoconductor drum 11, an opening 77 extending in the axial direction of the photoconductor drum 11. The housing 70 accommodates two-component developer 4 containing non-magnetic toner and carrier. The housing 70 accommodates: the developing roller 71, which is an example of a developer holding member, disposed so as to be partially exposed to the outside from the opening 77; the stirring-supply member 72, which is an example of a rotary part and may be a screw auger, rotatably disposed on the side of the developing roller 71 opposite to the opening 77; the stirring-transport member 73, which is an example of a rotary part and may be a screw auger, rotatably disposed below and slightly to the side of the stirring-supply member 72; and the stirring-collecting member 74, which is an example of a rotary part and may be a screw auger, rotatably disposed below and slightly to the side of the developing roller 71.

The housing 70 has, therein, first and second developer chambers 79 and 80 partitioned by a first partition 78 provided between the stirring-supply member 72 and the stirring-transport member 73, and a third developer chamber 82 partitioned by a second partition 81 provided between the stirring-transport member 73 and the stirring-collecting member 74. These developer chambers have semi-cylindrical cross-sections.

The stirring-supply member 72 is rotatably disposed in the first developer chamber 79. The stirring-transport member 73 is rotatably disposed in the second developer chamber 80. The stirring-collecting member 74 is rotatably disposed in the third developer chamber 82.

As illustrated in FIG. 2, the developing roller 71 includes: a magnet roller 711, which is stationarily disposed on the inner side and has multiple magnetic poles of certain polarities disposed at predetermined positions in the circumferential direction; and a cylindrical developing sleeve 712, which is rotatably disposed on the outer circumference of the magnet roller 711 and rotates in the arrow direction while holding the developer on the surface thereof. The layer-thickness regulating member 75 is provided above the developing roller 71 to regulate the layer thickness of the developer 4 held on the surface of the developing roller 71.

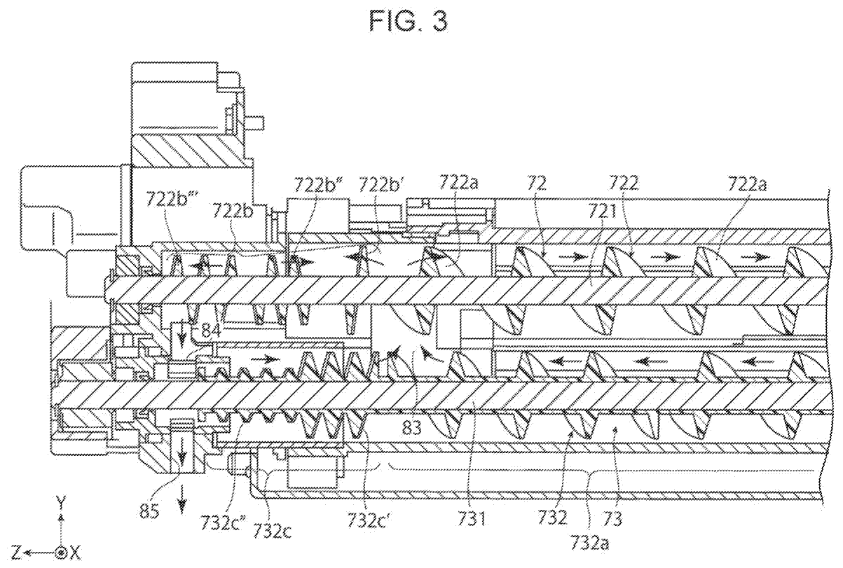

As illustrated in FIG. 3, the stirring-supply member 72 is a screw auger including a rotary shaft 721 made of a metal, such as stainless steel, and a transport blade 722 made of a synthetic resin. The transport blade 722 is integrally provided on the outer circumference of the rotary shaft 721. In the stirring-supply member 72, both the rotary shaft 721 and the transport blade 722 may be made of a synthetic resin. The transport blade 722 of the stirring-supply member 72 includes a leading transport blade 722a and a collecting transport blade 722b. The leading transport blade 722a transports the developer 4 transported from the stirring-transport member 73 through the first communication hole 83 to the rear side (right side in the drawing) in the axial direction. The collecting transport blade 722b is provided at the upstream end in the transport direction with the leading transport blade 722a and transports the developer 4 in the direction opposite to the transport direction with the leading transport blade 722a to collect a portion of the developer 4 supplied from the stirring-transport member 73.

In order to regulate the amount of the developer 4 to be collected to a very small level, the collecting transport blade 722b includes: one turn of a first reverse transport blade 722b′, which has a large outer diameter; two to three turns of a forward transport blade 722b″, which is disposed upstream of the first reverse transport blade 722b′ in the axial direction and has a smaller outer diameter than the first reverse transport blade 722b′; and two to three turns of a second reverse transport blade 722b″, which has a smaller outer diameter than the first reverse transport blade 722b′ and collects the developer that has passed through the forward transport blade 722b″.

The developer 4 to be collected, which has been transported by the collecting transport blade 722b, is discharged outside the housing 70 of the developing device 14 through a first collecting port 84 provided in the first partition 78 and a second collecting port 85 provided in the housing 70 and is collected. The developer to be collected, which has been discharged through the second collecting port 85, is collected by a collecting device (not illustrated) disposed on the front side of the developing device 14.

The developer 4 that has been transported to the rear end in the axial direction by the stirring-supply member 72 is transferred to the stirring-transport member 73 through a second communication hole (not illustrated).

As illustrated in FIG. 3, the stirring-transport member 73 is a screw auger including a rotary shaft 731 made of a metal, such as stainless steel, and a transport blade 732 made of a synthetic resin. The transport blade 732 is integrally provided on the outer circumference of the rotary shaft 731 so as to cover the rotary shaft 731. The transport blade 732 of the stirring-transport member 73 includes a leading transport blade 732a, an auxiliary transport blade (not illustrated), and a reverse transport blade 732c. The leading transport blade 732a transports the developer 4 transported from the stirring-supply member 72 through the second communication hole in the axial direction. The auxiliary transport blade is provided at the upstream end of the leading transport blade 732a in the transport direction and transports the toner and the developer supplied from a toner cartridge 76 to the leading transport blade 732a. The reverse transport blade 732c is provided at the downstream end of the leading transport blade 732a in the transport direction and transports the developer 4 transported by the leading transport blade 732a in the direction opposite to the transport direction with the leading transport blade 732a so as to push up and transport the developer 4 to the stirring-supply member 72, which is located vertically above the stirring-transport member 73.

The reverse transport blade 732c includes a first reverse transport blade 732c′, which has the same outer diameter as the leading transport blade 732a and a smaller pitch than the leading transport blade 732a, and a second reverse transport blade 732c″, which has a smaller outer diameter than the leading transport blade 732a and a smaller pitch than the leading transport blade 732a. When the developer to be collected is accumulated between the first collecting port 84 and the second collecting port 85, the second reverse transport blade 732c″ transports the developer to the stirring-transport member 73.

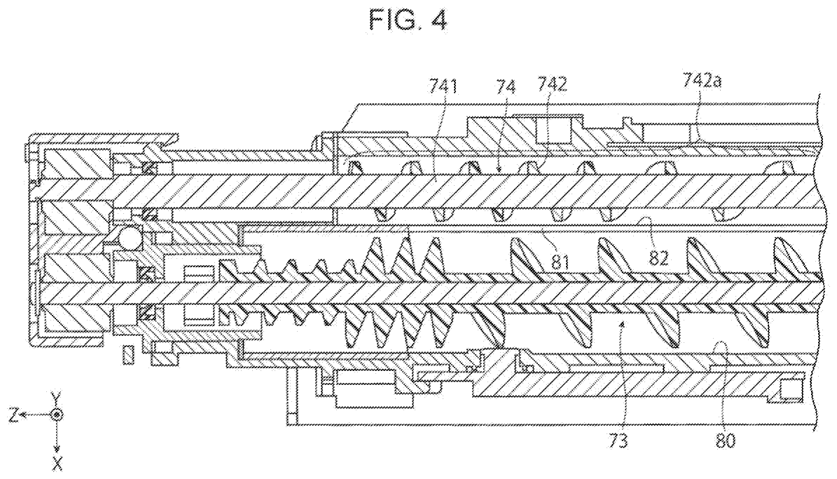

As illustrated in FIG. 4, the stirring-collecting member 74 is a screw auger including a rotary shaft 741 made of a metal, such as stainless steel, and a transport blade 742 made of a synthetic resin. The transport blade 742 is integrally provided on the outer circumference of the rotary shaft 741. The stirring-collecting member 74 has a smaller outer diameter than the stirring-transport member 73. The transport blade 742 of the stirring-collecting member 74 includes a leading transport section 742a and a reverse transport section. The leading transport section 742a transports the developer 4 separated and falling from the developing roller 71 toward the rear side in the axial direction. The reverse transport section is provided at the downstream end of the leading transport section 742a in the transport direction and transports the developer 4 transported by the leading transport section 742a in the reverse direction toward the upstream side in the axial direction. The developer 4 transported by the stirring-collecting member 74 is transferred to the stirring-transport member 73 through a third communication hole (not illustrated) and is transported again by the stirring-transport member 73.

In this developing device 14, the housing 70 accommodates, in a rotatable manner, rotary parts, such as the stirring-supply member 72, the stirring-transport member 73, and the stirring-collecting member 74. The stirring-supply member 72, the stirring-transport member 73, and the stirring-collection member 74 are rotatably supported at both ends thereof, in the axial direction of the rotary shafts 721, 731 and 741, with bearings. The ends of the stirring-supply member 72, the stirring-transport member 73, and the stirring-collecting member 74 in the axial direction of the rotary shafts 721, 731, and 741 are sealed by seal members that are made of, for example, synthetic rubber to prevent the developer from leaking outside at positions on the inner sides of the bearings in the axial direction.

Hence, in the developing device 14, if the numbers of rotations of the stirring-supplying member 72, the stirring-transport member 73, and the stirring-collecting member 74 are increased to achieve higher productivity of the image forming apparatus 1, the seal members heat up due to frictional heat generated between the seal members and the rotary shafts 721, 731 and 741 of the stirring-supply member 72, the stirring-transport member 73, and the stirring-collecting member 74.

When the seal members heat up, the developer 4 around the seal members becomes more likely to aggregate. If the aggregated developer 4 is supplied to the developing roller 71, a development failure, such as a white spot, may occur in an image developed on the photoconductor drum 11.

Furthermore, if the seal members heat up, causing the developer to aggregate at the positions of the seal members, the stirring-supply member 72, the stirring-transport member 73, the stirring-collecting member 74, and the like may not rotate properly, possibly causing an operation failure of the developing device 14.

To address these problems, as described above, Japanese Unexamined Patent Application Publication Nos. 2015-082056 and 2003-057927 have proposed a configuration in which heat generated in a developing unit is released into a space via a protrusion, and a configuration in which a vent hole is provided so as to communicate between a space between a bearing and a seal member in the axial direction and the outside of a developing device.

However, in the configurations disclosed therein, the heat of the seal members are not directly released. Thus, heating up of the seal members is not sufficiently suppressed.

The developing device according to the first exemplary embodiment includes a heat releasing part that is made of a material having a higher thermal conductivity than the housing. The heat releasing part is in contact with the seal part and releases heat of the seal part to the outside. The stirring-transport member 73 will be described as an example of the rotary part. The stirring-supply member 72 and the stirring-collecting member 74 have same configuration as the stirring-transport member 73.

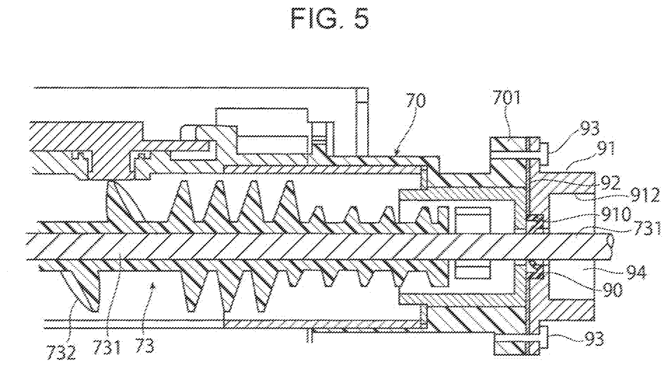

As illustrated in FIG. 5, in the developing device 14 according to the first exemplary embodiment, one end of the stirring-transport member 73 in the axial direction of the rotary shaft 731 is sealed by a sealing member 90, which is an example of a seal part.

The entire outer circumferential surface of the seal member 90 is in contact with a heat releasing member 91 at an end 701 of the housing 70, which is made of a synthetic resin, in the longitudinal direction. The heat releasing member 91 is made of a metal, such as aluminum or stainless steel, having a higher thermal conductivity than the housing 70, which is made of a synthetic resin. The surface of the heat releasing member 91 is insulated by, for example, nitriding. The heat releasing member 91 is attached in a sealed manner to the end 701 of the housing 70 in the longitudinal direction by screws 93 or the like with a packing 92 made of, for example, a rubber sheet or a urethane sheet therebetween. The heat releasing member 91 is exposed at the end 701 of the housing 70 of the developing device 14 in the longitudinal direction.

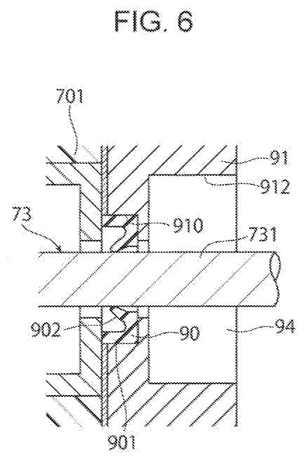

The heat releasing member 91 has a recess 910 for accommodating the seal member 90 in the end face thereof facing the housing 70. As illustrated in FIG. 6, the seal member 90 is made of an elastic material, such as synthetic rubber, and includes a seal body 901 and a lip portion 902. The seal body 901 is located on the outer circumferential side and fixed to the heat releasing member 91. The lip portion 902, which is an elastic piece, extends toward the inner circumference of the seal body 901 and is in tight contact with the outer circumferential surface of the rotary shaft 731 of the stirring-transport member 73 to seal the developer 4.

As illustrated in FIG. 5, the end of the rotary shaft 731 of the stirring-transport member 73 in the axial direction is rotatably supported by the housing 70 via a bearing 94 at a position on the outer side of the seal member 90. A drive gear or the like (not illustrated) that rotationally drives the stirring-transport member 73 is attached to an end of the rotary shaft 731 of the stirring-transport member 73 in the axial direction.

The heat releasing member 91 has, on the outside of the housing 70, a recess 912 for holding the bearing 94. The bearing 94 does not necessarily have to be held by the heat releasing member 91, and may be held at the end 701 of the housing 70.

Although the seal structure of the rotary part has been described using the stirring-transport member 73 as an example, the stirring-supply member 72 and the stirring-collecting member 74 have same configuration as the stirring-transport member 73, as described above.

### Operation of Developing Device

The developing device according to the first exemplary embodiment can release, directly to the outside, heat of the seal part that seals the end of the rotary part, such as the stirring-supply member, the stirring-transport member, or the stirring-collecting member, in the axial direction, as follows. It is only necessary that at least a part of the heat releasing part in contact with the seal part be exposed to the outside of the housing of the developing device. In other words, it is not necessary for the entire heat releasing part to be exposed to the outside.

As illustrated in FIG. 1, in the developing device according to the first exemplary embodiment, when a toner supply device (not illustrated) is driven, toner including toner and carrier is supplied from the toner cartridge 76 into the housing 70 through a supply pipe 76a.

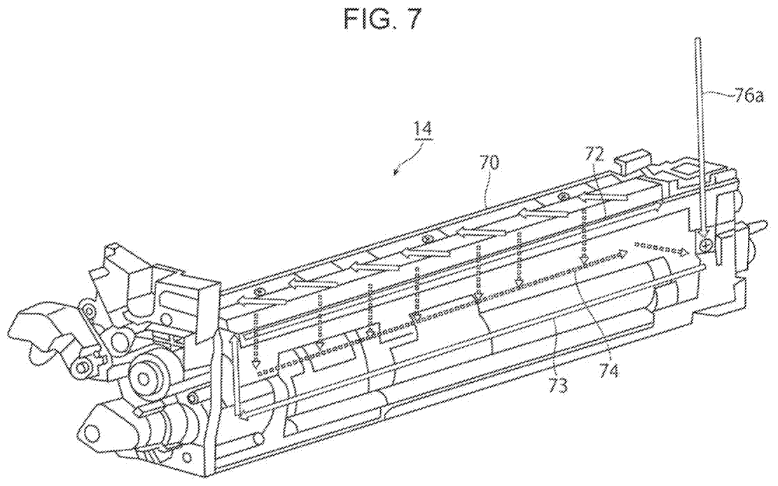

The developer containing the toner supplied into the housing 70 falls from the toner supply port to one end of the stirring-transport member 73 through the stirring-supply member 72, as illustrated in FIG. 7, and is transported to the front side in the axial direction by the stirring-transport member 73, as illustrated in FIG. 3.

As illustrated in FIG. 3, the developer supplied into the housing 70 is mixed with the developer 4 that is already stored in the housing 70 while being transported to the front side in the axial direction by the stirring-transport member 73 and, thus, is charged to a required polarity by friction.

As illustrated in FIG. 3, the developer 4 transported to the front end in the axial direction by the stirring-transport member 73 is transferred to the stirring-supply member 72, which is positioned vertically above the stirring-transport member 73, through the first communication hole 83. The stirring transport member 73 has, at the front end thereof in the axial direction, the reverse transport blade 732c for transporting, in the reverse direction, the developer 4 transported by the stirring transport member 73. With this configuration, the developer 4 transported to the front end of the stirring-transport member 73 is transferred to the stirring-supply member 72, which is positioned vertically above the stirring-transport member 73, by the transport action of the leading transport blade 732a and the reverse transport blade 732c of the stirring-transport member 73.

The stirring-supply member 72 transports the developer 4 transferred from the stirring-transport member 73 toward the rear end in the axial direction and supplies the developer 4 to the developing roller 71. The developing roller 71 supplied with the developer 4 from the stirring-supply member 72 visualizes and develops the electrostatic latent image formed on the surface of the photoconductor drum 11 with toner of a certain color in the developing area facing the photoconductor drum 11, while transporting the developer 4 with rotation of the developing sleeve 712.

The developer 4 that has not been supplied from the stirring-supply member 72 to the developing roller 71 is transported to the end in the axial direction by the stirring-supply member 72 and is transported to the stirring-transport member 73 through the second communication hole provided at the end in the axial direction of the stirring-supply member 72.

Of the developer supplied to the developing roller 71, the developer 4 that has not been used to develop the electrostatic latent image on the photoconductor drum 11 is separated from the surface of the developing roller 71 by a separation magnetic pole (not illustrated) of the magnet roller 711 of the developing roller 71 and is supplied to the stirring-collecting member 74.

The developer 4 supplied to the stirring-collecting member 74 is transported to the rear end by the stirring-collecting member 74 and then to the stirring-transport member 73 through the third communication hole.

As illustrated in FIGS. 3 and 4, the axial ends of the stirring-supply member 72, the stirring-transport member 73, and the stirring-collecting member 74 are rotatably supported by the housing 70. As illustrated in FIG. 5, the axial ends of the stirring-supply member 72, the stirring-transport member 73, and the stirring-collecting member 74 are sealed by the sealing members 90 to prevent the developer 4 from leaking out of the housing 70.

As illustrated in FIGS. 5 and 6, in the developing device 14 according to the first exemplary embodiment, the heat releasing members 91 are in contact with the outer circumferential surfaces of the seal members 90. The heat releasing members 91 are made of a metal having a higher thermal conductivity than the synthetic resin constituting the housing 70.

Frictional heat generated between the seal members 90 and the axial ends of the stirring-supply member 72, the stirring-transport member 73, and the stirring-collecting member 74 of the rotary shafts 721, 731 and 741 is directly transmitted to the heat releasing members 91 by thermal conduction and is released outside by the heat releasing members 91.

### Second Exemplary Embodiment

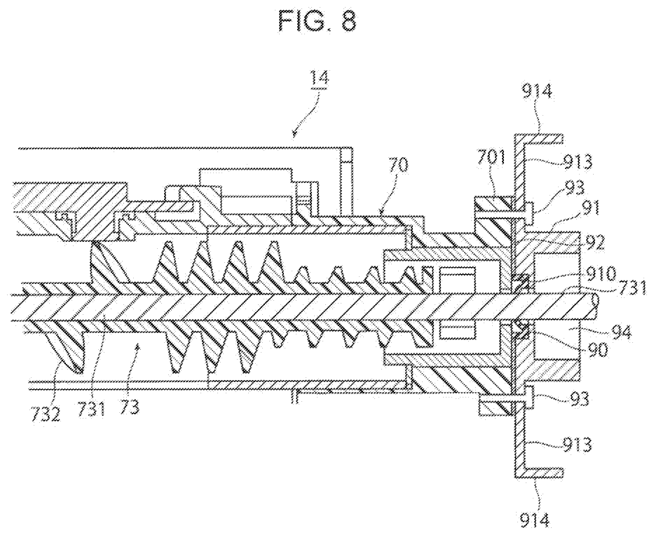

FIG. 8 illustrates a configuration of a developing device according to a second exemplary embodiment of the present disclosure. The same members as those in the first exemplary embodiment are denoted by the same reference numerals.

As illustrated in FIG. 8, in the developing device 14 according to the second exemplary embodiment, the heat releasing member 91 does not have the same sectional shape as the end 701 of the housing 70 in the longitudinal direction. To improve the heat releasing property of the heat releasing member 91, an end 913 of the heat releasing member 91, the end 913 being flat-plate-shaped and extending in a direction intersecting the longitudinal direction of the housing 70, extends radially outward so as to largely protrude outward from the end 701 of the housing 70 in the longitudinal direction.

The heat releasing member 91 may have any shape, such as a rectangular shape or a circular shape, in side view. A heat releasing fin 914 extending in the direction parallel to the rotary shaft 731 of the stirring-transport member 73, which is a direction intersecting the heat releasing member 91, is provided at the end 913 of the heat releasing member 91 so as to be integral therewith.

Since the other configurations and operations are the same as those in the first exemplary embodiment, the description thereof will be omitted.

### Third Exemplary Embodiment

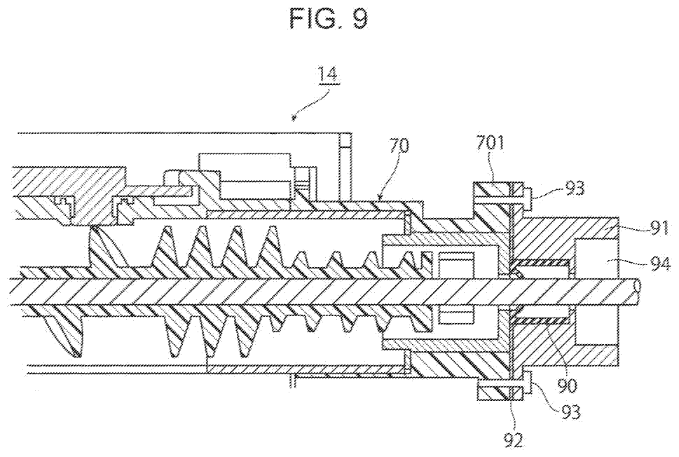

FIG. 9 illustrates a configuration of a developing device according to a third exemplary embodiment of the present disclosure. The same members as those in the first exemplary embodiment are denoted by the same reference numerals.

As illustrated in FIG. 9, in the developing device 14 according to the third exemplary embodiment, the seal member 90 is elongated in the axial direction of the stirring transport member 73 to achieve a larger contact area between the seal member 90 and the heat releasing member 91 than that in the first exemplary embodiment. The heat releasing member 91 is also elongated in the axial direction so as to be in contact with the entire outer circumferential surface of the seal member 90.

Since the other configurations and operations are the same as those in the first exemplary embodiment, the description thereof will be omitted.

### Fourth Exemplary Embodiment

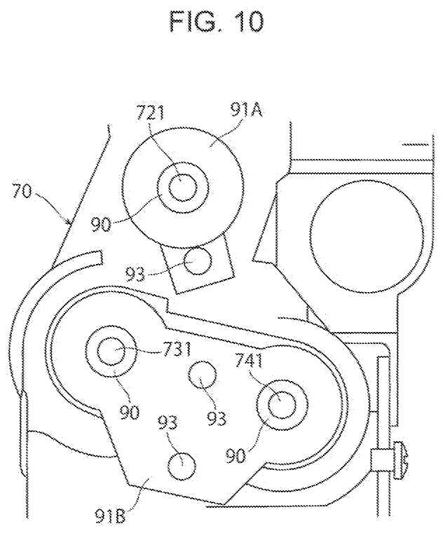

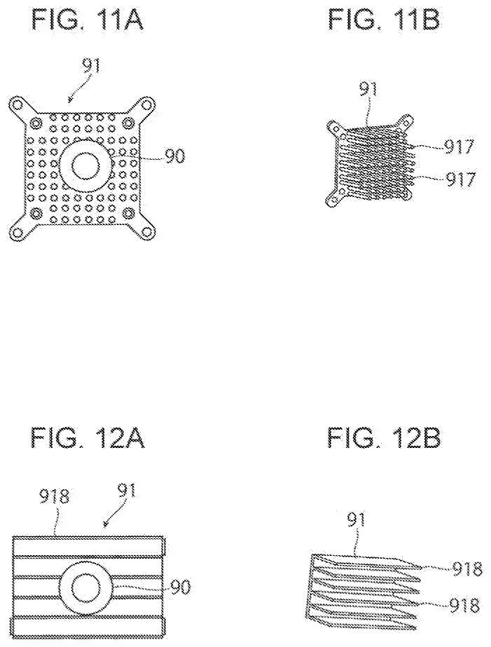

FIGS. 10, 11A and 11B show a configuration of a developing device according to a fourth exemplary embodiment of the present disclosure. The same members as those in the first exemplary embodiment are denoted by the same reference numerals.

As illustrated in FIGS. 10, 11A and 11B, in the developing device 14 according to the fourth exemplary embodiment, the shape of the heat releasing member 91 is different from that in the first exemplary embodiment and the like. The heat releasing member 91 does not need to be provided individually for each of the stirring-feeding member 72, the stirring-transport member 73, and the stirring-collecting member 74. As illustrated in FIG. 10, an individual heat releasing member 91A for the stirring-feeding member 72 and a common heat releasing member 91B for the stirring-transport member 73 and the stirring-collecting member 74 may be provided.

Furthermore, in the developing device 14 according to the fourth exemplary embodiment, the heat releasing member 91 may include a planar member and multiple pin-shaped projections 917 provided thereon (see FIGS. 11A and 11B) or a planar member and multiple planar projections 918 provided thereon (see FIGS. 12A and 12B).

Furthermore, an air blower, such as a fan (not illustrated), may be provided in a rear or side surface of the housing 70 of the developing device 14 to form an air flow directed to the heat releasing member 91.

Since the other configurations and operations are the same as those in the first exemplary embodiment, the description thereof will be omitted.

Although the full-color image forming apparatus has been described in the above-described exemplary embodiments, the present disclosure can of course be applicable to a monochrome image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A developing device comprising: a housing; a rotary part that is rotatably disposed in the housing; a seal part that seals an end of the rotary part in an axial direction; and a heat releasing part that is made of a material having a higher thermal conductivity than the housing and that is in contact with the seal part to release heat of the seal part to the outside.

(((2)))

The developing device according to (((1))), wherein the rotary part is a transport part that transports developer stored in the housing.

(((3)))

The developing device according to (((2))), wherein the transport part includes a transport blade that transports, in a reverse direction, the developer that has been transported to an end of the transport part in the axial direction.

(((4)))

The developing device according to (((1))), wherein the heat releasing part is disposed so as to be in contact with at least an end of an outer circumference of the seal part in a radial direction.

(((5)))

The developing device according to (((4))), wherein the heat releasing part has a holding portion that holds a bearing for rotatably supporting the rotary part.

(((6)))

The developing device according to (((1))), wherein the heat releasing part has a protruding portion protruding outward from the housing in a radial direction, which intersects a rotation axis of the rotary part.

(((7)))

The developing device according to (((6))), wherein the heat releasing part has a heat releasing fin on the protruding portion.

(((8)))

The developing device according to (((1))), wherein the seal part is long in the axial direction of the rotary part.

(((9)))

The developing device according to (((8))), wherein the heat releasing part is in contact with the long seal part to increase a contact area between the heat releasing part and the seal part.

(((10)))

The developing device according to (((1))), wherein the heat releasing part is made of a metal.

(((11)))

The developing device according to (((10))), wherein the heat releasing part that is made of a metal is insulated.

(((12)))

The developing device according to (((11))), wherein the heat releasing part is insulated by nitriding.

(((13)))

An image forming apparatus comprising: a latent image forming part that forms an electrostatic latent image on an image carrier; and a developing part that develops the electrostatic latent image on the image carrier, wherein the developing part uses the developing device according to any one of (((1))) to (((12))).

What is claimed is:

1. A developing device comprising:
a housing;
a rotary part that is rotatably disposed in the housing;
a seal part that seals an end of the rotary part in an axial direction; and
a heat releasing part that is made of a material having a higher thermal conductivity than the housing and that is in contact with the seal part to release heat of the seal part to the outside.

2. The developing device according to claim 1, wherein the rotary part is a transport part that transports developer stored in the housing.

3. The developing device according to claim 2, wherein the transport part includes a transport blade that transports, in a reverse direction, the developer that has been transported to an end of the transport part in the axial direction.

4. The developing device according to claim 1, wherein the heat releasing part is disposed so as to be in contact with at least an end of an outer circumference of the seal part in a radial direction.

5. The developing device according to claim 4, wherein the heat releasing part has a holding portion that holds a bearing for rotatably supporting the rotary part.

6. The developing device according to claim 1, wherein the heat releasing part has a protruding portion protruding outward from the housing in a radial direction, which intersects a rotation axis of the rotary part.

7. The developing device according to claim 6, wherein the heat releasing part has a heat releasing fin on the protruding portion.

8. The developing device according to claim 1, wherein the seal part is long in the axial direction of the rotary part.

9. The developing device according to claim 8, wherein the heat releasing part is in contact with the long seal part to increase a contact area between the heat releasing part and the seal part.

10. The developing device according to claim 1, wherein the heat releasing part is made of a metal.

11. The developing device according to claim 10, wherein the heat releasing part that is made of a metal is insulated.

12. The developing device according to claim 11, wherein the heat releasing part is insulated by nitriding.

13. An image forming apparatus comprising:
a latent image forming part that forms an electrostatic latent image on an image carrier; and
a developing part that develops the electrostatic latent image on the image carrier,
wherein the developing part uses the developing device according to claim 1.

14. An image forming apparatus comprising:
a latent image forming part that forms an electrostatic latent image on an image carrier; and
a developing part that develops the electrostatic latent image on the image carrier,
wherein the developing part uses the developing device according to claim 2.

15. An image forming apparatus comprising:
a latent image forming part that forms an electrostatic latent image on an image carrier; and
a developing part that develops the electrostatic latent image on the image carrier,
wherein the developing part uses the developing device according to claim 3.

16. An image forming apparatus comprising:
a latent image forming part that forms an electrostatic latent image on an image carrier; and
a developing part that develops the electrostatic latent image on the image carrier,
wherein the developing part uses the developing device according to claim 4.

17. An image forming apparatus comprising:
a latent image forming part that forms an electrostatic latent image on an image carrier; and
a developing part that develops the electrostatic latent image on the image carrier,
wherein the developing part uses the developing device according to claim 5.

18. An image forming apparatus comprising:
a latent image forming part that forms an electrostatic latent image on an image carrier; and
a developing part that develops the electrostatic latent image on the image carrier,
wherein the developing part uses the developing device according to claim 6.

19. An image forming apparatus comprising:
a latent image forming part that forms an electrostatic latent image on an image carrier; and
a developing part that develops the electrostatic latent image on the image carrier,
wherein the developing part uses the developing device according to claim 7.

20. An image forming apparatus comprising:
a latent image forming part that forms an electrostatic latent image on an image carrier; and
a developing part that develops the electrostatic latent image on the image carrier,
wherein the developing part uses the developing device according to claim 8.
